(19) United States
(12) Patent Application Publication
(10) Pub. No.: US 2008/0135071 A1
(43) Pub. Date: Jun. 12, 2008

(54) Foam system

(76) Inventors: James P. Kelley, Houston, TX (US); Fred A. Sieber, Houston, TX (US)

Correspondence Address: William P. Glenn, Jr., Suite 205, 2102 Mechanic Street, Galveston, TX, 77550, US

(21) Appl. No.: 11/982,685

(22) Filed: Nov. 2, 2007

Related U.S. Application Data
(60) Provisional application No. 60/874,196, filed on Dec. 11, 2006.

(51) Int. Cl. B08B 9/08; B08B 13/00

(52) U.S. Cl. 134/103.2; 134/115 R; 134/166 R

(57) ABSTRACT

The present invention is directed to the creation and delivery of foam to displace the vapor space of an enclosed structure of residual material suspended in the vapor space to the outside. The foam accumulates in the enclosed structure to urge the residual material suspended in the vapor space to exit the enclosed structure via an exhaust duct.

### CROSS REFERENCE TO RELATED APPLICATIONS

This application claims priority to U.S. Provisional Application 60/874,196, filed Dec. 11, 2006, and any subsequent non provisional applications.

### DESCRIPTION

1. Technical Field

This invention relates generally to the cleaning of enclosed structures and the associated systems of residual material. More particularly, it relates to the degassing and cleaning of vessels, tanks, and/or piping. More specifically, this invention relates to the use of foam system to degas and clean vessels, tanks and/or piping of residual material.

2. Background of the Invention

Traditionally, degassing and cleaning of vessels, tanks and/or piping of residual material included opening the enclosed structure and venting, steaming and/or washing the residual material out and into the environment. However, this traditional means of degassing and cleaning has been regulated to eliminate or at least reduce the amount of residual material being introduced into the environment. Of recent concern and regulation is the amount of residual material in the form of volatile organic compounds (VOC) introduced into the atmosphere. See 40 CFR Part 63.

The traditional degassing method of venting the enclosed structure (naturally or through force gas systems—such as blowers) lowers the concentration of the airborne residual material in the structure by adding large volumes of a dilution medium, such as air or inert gas. For example, when such a method is used to degas a storage tank, the effectiveness of the dilution drops off with time. For instance, with a tank of 133,975 cubic feet of space to be degassed, the time interval to lower the concentration of benzene from 41,933 ppm to 100 ppm with a forced ventilation flow of 200 cubic feet per minute is approximately 67.4 hours. See Chart 1. The disadvantages of such a system are numerous.

One major disadvantage of the traditional dilution method of degassing is the significant drop off in the efficiency of lowering the concentration of residual material suspended in a vapor space inside the enclosed structure. As shown in Chart 1, about ¾^{ths} of the residual benzene suspended in a tank's vapor space is removed in approximately the first 15 hours of the process—but removal of the remaining residual benzene to 100 ppm takes the remaining time, or approximately 52 hours. In short, the majority of time and dilution gas spent to degas an enclosed structure is related to extraction of the approximately last fourth of the residual material suspended in the vapor space of the enclosed structure.

Furthermore, the traditional dilution method of degassing flammable residual material within an enclosed structure by using air as the dilution gas will result in a period of time in which the concentration of flammable residual material moves through its upper and lower explosive limits. The flow rate can be increased and/or an inert dilution gas can be used to eliminate or at least reduce explosive conditions during dilution degassing.

As it can be appreciated, degassing residual materials, such as VOC's, directly to the atmosphere will violate Federal and State air emission standards. In such situations, the concentration of residual material released into the atmosphere is regulated by a control unit. Such control units can be in the form of thermal destructors, refrigerated condensers, absorption or chemical reactors, absorbers or scrubbers, activated carbon adsorption units and catalytic oxidation devices.

Thermal destructor control units typically require the use of an open flame, thermal oxidizer and/or internal combustion or turbine engine. However, thermal destruction typically creates and emits CO₂ and/or NO_{X} into the atmosphere. Combustion products include CO₂, CO, NO_{X} and since no technology is 100% efficient, some residual material will also be emitted into the atmosphere. This coupled with the inefficiency of the dilution method requires the prolonged use of makeup fuel to complete the thermal destruction of the residual material during most of the degassing process. Similar problems occur with absorbers and carbon adsorption units in that large amount of waste (liquid or solid) may result from control of residual material emissions during the traditional dilution method of degassing an enclosed structure.

Finally, the traditional dilution method of degassing provides no means of cleaning residual material that remains in the enclosed structure as a liquid, solid or a combination thereof. In short, the traditional dilution method is limited to removal of residual material suspended in the vapor space of the enclosed structure.

The above illustrates the drawbacks of the traditional dilution method of degassing an enclosed structure. In short, the traditional techniques currently known and used are inefficient, expensive, provide no means to eliminating residual material in liquid form, and do not leave the enclosed structure in a clean condition.

The invention disclosed in the following sections eliminates or reduces the limitations discussed above. The present invention provides a new and novel use of foam to safely degas and clean an enclosed structure of residual material in a shorter amount of time. The invention further provides the advantage of being able to efficiently, and at lower costs, degas and clean a variety of enclosed structures, including but not limited to vessels, storage tanks (floating roof and otherwise), piping and associated systems. And, it reduces overall emission of air pollutants during degassing, since the degassing step requires less time (less time burning).

### SUMMARY OF THE INVENTION

The present invention includes the creation and delivery of foam 10 to displace the vapor space 108 of an enclosed structure 100 to the atmosphere 110 outside the enclosed structure 100 via an exhaust duct 30. A sufficient volume of foam 10 is created by a foam generator 20 which combines a sufficient volume of foam concentrate 12 from a foam concentrate source 22 with a sufficient volume of water 14 from a water source 24 and a sufficient volume of gas 16 from a gas source 26. As foam 10 accumulates in the enclosed structure 100, the airborne residual material 106 suspended in the vapor space 108, as well as the vapor space 108, is urged to exit the enclosed structure 100 via an exhaust duct 30 to be directed to the external atmosphere 110, control unit 40 or reintroduced to enclosed structure 100. In the alternative, a sufficient volume of foam solution 11, consisting of foam concentrate 12 and water 14, can be expanded with a sufficient volume of gas 16 from a gas source 26 in a foam generator 20 to create a sufficient volume of foam 10.

Control unit 40 eliminates or at least reduces the concentration of residual material 106 suspended in the internal atmosphere 108 before emission to the external atmosphere 110. Control unit 40 can be an open flame combustion device such as a flare, thermal oxidizer, internal combustion engine, refrigerated condenser, absorber, adsorber, scrubber, catalytic oxidizer, and/or chemical oxidizer/reducer.

It is contemplated that residual material 106 can be the remnants of the material stored, processed or conveyed in the enclosed structure 100. It is further contemplated that residual material 106 can be a liquid, gas, solid or a combination thereof.

### BRIEF DESCRIPTION OF THE DRAWINGS

FIG. 1 is a schematic view of an embodiment of the present invention.

FIG. 2 is a schematic view of an embodiment of the present invention.

FIG. 3 is a schematic view of an embodiment of the present invention.

FIG. 4 is a schematic view of an embodiment of the present invention.

FIG. 5 is a schematic view of an embodiment of the present invention.

FIG. 6 is a schematic view of an embodiment of the present invention.

### DETAILED DESCRIPTION OF THE INVENTION

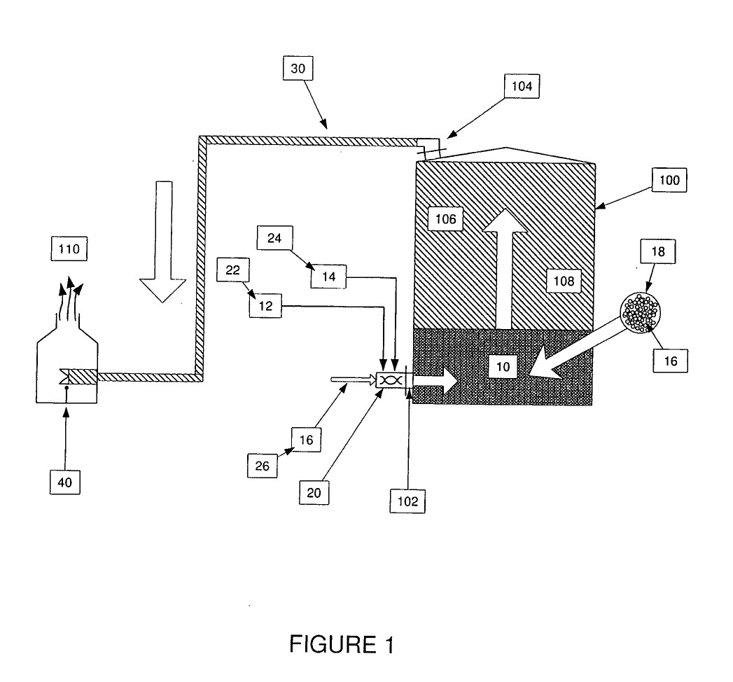

In its most simplest form as shown in FIG. 1, the present invention comprises a foam generator 20 fluidly connected to a foam concentration source 22, a water source 24 and a gas source 26 to combine foam concentrate 12, water 14 and gas 16 to generate a foam 10 of a sufficient volume to displace the vapor space 108 of an enclosed structure 100 to a exhaust duct 30 by an outlet 104.

The modeling to date demonstrates that the time to degas a 133,975 cubic foot storage tank containing 41,933.2 ppm of benzene to a concentration of 0 ppm with foam 10 takes an elapsed time of 12 hours. See Chart 1. This is a time saving of more than approximately 50 hours to reach 100 ppm over the traditional dilution degassing method described above. The foam displacement degassing method further eliminates the concerns about creating an explosive environment within the enclosed structure since very little or no dilution is created with the introduction of gas 16 into the vapor space 108. This is because the gas 16 introduced into the enclosed space is contained within the plurality of bubbles 18 which makeup the foam 10 and does not significantly mix with the vapor space 108. Because the airborne residual matter 106 is pushed out of the enclosed structure 100 by the foam 10 at its original concentration, the control unit 40 is operated in a more efficient manner.

The foam generator 20 can be of any type which is capable of mixing foam concentrate 12, water 14 and gas 16 in the proper proportions to create a finished homogenous foam capable of withstanding spontaneous collapse or break down. The foam generator 20 can be physically located inside or outside of the enclosed structure 100. If located outside the enclosed structure, as depicted in FIG. 1, foam generator 20 is fluidly connected to enclosed structure 100 by an inlet 102 to convey foam 10 inside the enclosed structure 100.

Foam 10 is contemplated to be an aeration by a gas 16 of any solution 11 which creates a stable or at least a semi-stable plurality of bubbles 18. The foam concentrate 12 can be comprised of any material which can create foam, including but not limited to protein, fluoroprotein, film forming fluoroprotein (FFFP), aqueous film forming foam (AFFF), synthetic/detergent (high expansion), alcohol resistant (AR-AFFF), wetting agent, Class A foam or a combination thereof. The gas 16 can be air, inert gas (such as nitrogen) or a combination thereof. The foam 10 can be low expansion, medium expansion or high expansion foam.

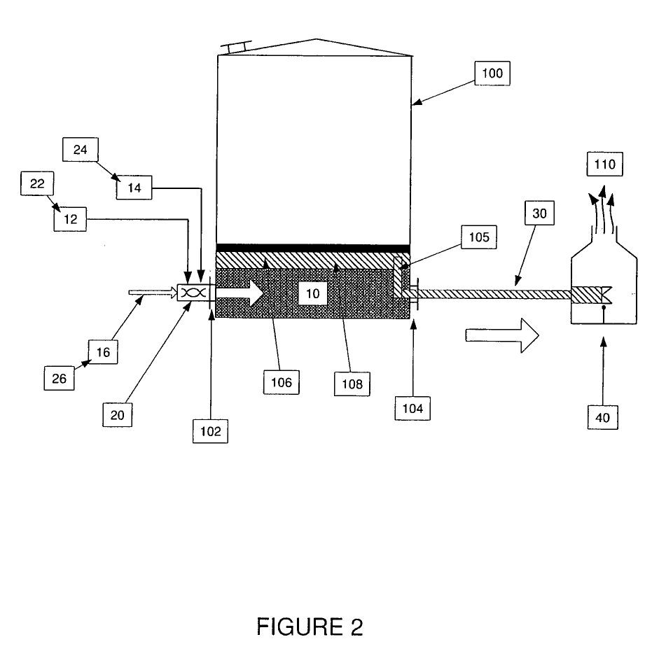

The exhaust duct 30 is fluidly connected at one end to an outlet 104 formed in the enclosed structure 100. The other end of exhaust duct 30 can be open to the external atmosphere 110 or fluidly connected to a control unit 40 (see FIGS. 1 and 2). As a sufficient volume of foam 10 is introduced into the enclosed structure 100, the residual material 106 suspended in the vapor space 108 is displaced or pushed through the outlet 104 and into the exhaust duct 30 to be eventually released to the atmosphere 110 and/or introduced into a control unit 40.

Outlet 104 can be located at the highest elevation of the enclosed structure 100 as shown in FIG. 1 or any other elevation of the enclosed structure 100. FIG. 2 shows outlet 104 at the same elevation as inlet 102. Typically if the enclosed structure 100 is a fixed roof storage tank, then outlet 104 is located at the top of the enclosed structure 100. If the enclosed structure 100 is a floating roof storage tank, as shown in FIG. 2, outlet 104 is near the bottom of the enclosed structure 100. If outlet 104 is at an elevation below the highest point of the enclosed structure 100, then it is contemplated that a vapor extension piece 105 can be fluidly connected at one end to the internal side of outlet 104 with the open end of vapor extension piece 105 located at or near the highest elevation of the enclosed structure 100 (See FIG. 2).

If foam 10 is created outside of the enclosed structure 100 as shown in FIGS. 1 and 2, then foam generator 20 is fluidly connected by an inlet 102 formed in the enclosed structure 100. The elevation of inlet 102 can be anywhere about the enclosed structure 100. In a preferred embodiment, inlet 102 is formed near the lowest elevation of enclosed structure 100.

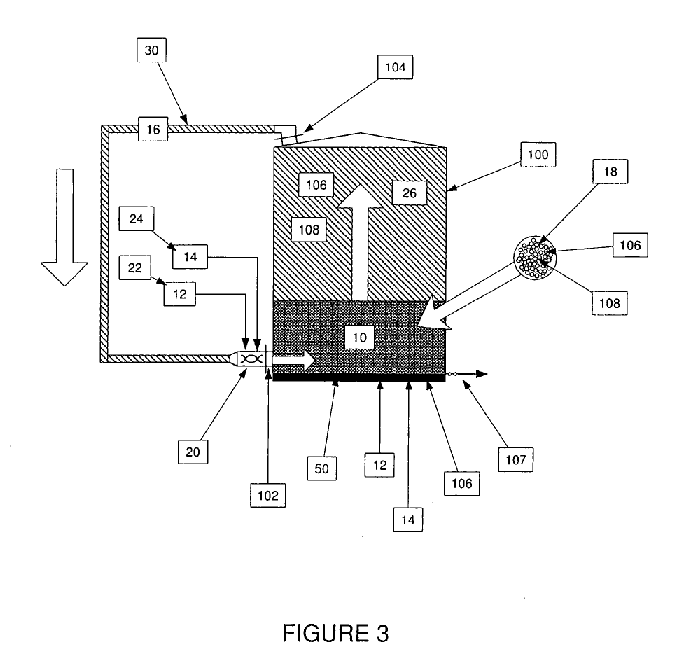

In another embodiment of the present invention, foam 10 is generated and circulated by the foam generator 20 through the enclosed structure 100 to encapsulate the residual material 106 suspended in the vapor space 108 in the plurality of bubbles 18 which make up foam 10 (See FIG. 3). Specifically, exhaust duct 30 is fluidly connected between outlet 104 and foam generator 20 to circulate foam 10 through enclosed structure 100. Furthermore, as shown in FIG. 3, gas source 26 is the vapor space 110 of enclosed structure 100. After a sufficient length of circulation time, foam 10 is allowed to collapse by virtue of the plurality of bubbles 18 bursting to form a condensate mixture 50 comprising foam concentrate 12, water 14 and residual material 106. Condensate mixture 50 is then pumped out of enclosed structure 100 leaving a vapor space 108 with no or at least a reduced concentration of residual material 106 suspended in the vapor space 108.

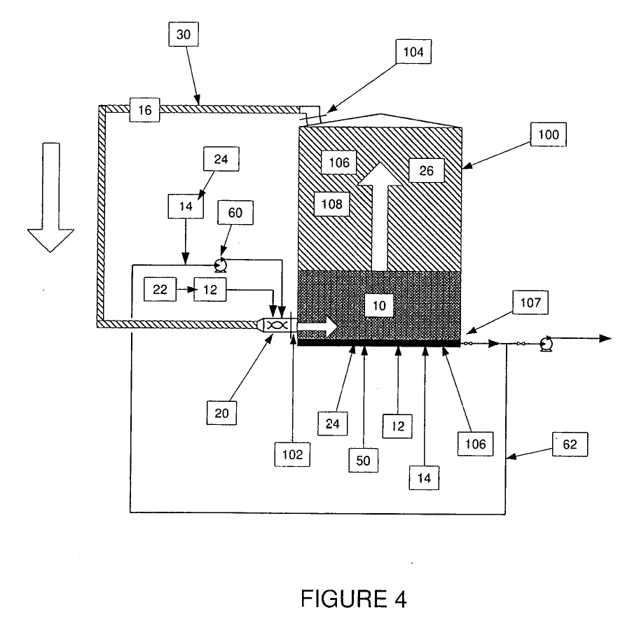

In yet another embodiment of the present invention, foam 10 is generated and circulated by the foam generator 20 as described above but with a recycle pump 60 fluidly connected between a drain 107 formed near the bottom of the enclosed structure 100 and foam generator 20 (See FIG. 4). In this configuration, a sufficient volume of foam 10 is continually circulated through the enclosed structure 100 to encapsulate the residual material 106 suspended in the vapor space 108 in the plurality of bubbles 18 which make up foam 10 (See FIG. 4). Because foam 10 has a certain amount of natural collapse of the plurality of bubbles 18, condensate 50 will form that can be circulated back to the foam generator 20 to reform the foam 10. Specifically, a recycle line 62 is fluidly connected between drain 107 and recycle pump 60. As can be appreciated, the introduction of condensate 50 to the foam generator 20 reduces the amount of required foam concentrate 12 and further increases the concentration of residual material 106 in condensate 50. After a sufficient length of circulation time, foam 10 is allowed to collapse by virtue of the plurality of bubbles 18 bursting to form a vapor barrier 48. Vapor barrier 48 prevents residual material 106 located at the bottom of enclosed structure 100 from becoming airborne. This enhances the evacuation of the airborne residual material 106 within vapor space 108. This is especially useful when the bottom of enclosed structure 100 is uneven or semi-porous. Vapor barrier 48 can be left in place until condensate 50 is pumped out.

In another embodiment, foam 10 is allowed to collapse by virtue of the plurality of bubbles 18 bursting to form a condensate 50 comprising foam concentrate 12, water 14 and residual material 106. Condensate 50 is then pumped out of enclosed structure 100 leaving a vapor space 108 with no or at least a reduced concentration of suspended residual material 106.

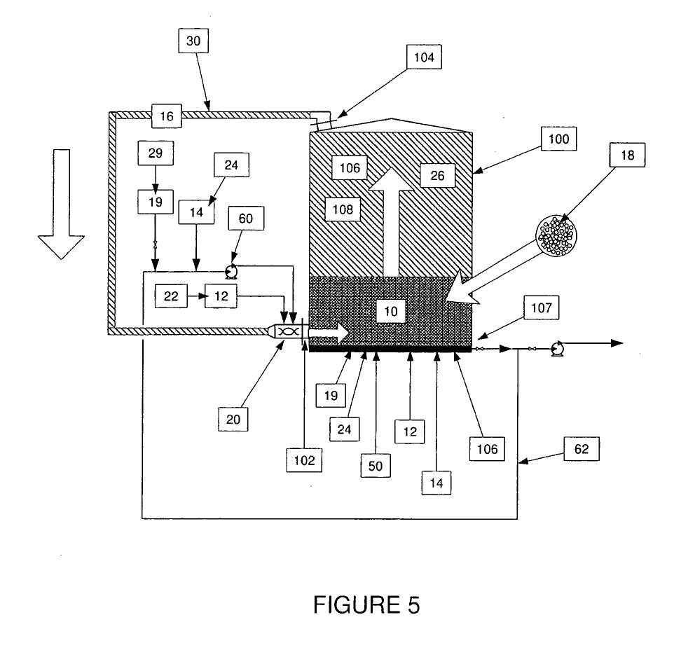

In yet another embodiment as shown in FIG. 5, foam 10 as described above further includes an extraction additive 19 which chemically and/or physically reacts with residual material 106 within the enclosed structure 100. This is especially important when the residual material 106 is insoluble and/or does not react with the foam concentrate 12 or gas 16. It is contemplated that extraction additive 19 is added at the foam generator 20 to ensure dispersion within the walls of the plurality of bubbles 18 which make up foam 10. Such dispersion of extraction additive 19 increases the likelihood of the residual material 106 suspended in the vapor space 108 or otherwise located in the enclosed structure 100 of being removed as part of condensate 50. Such an embodiment makes the foam 10 a cleaner.

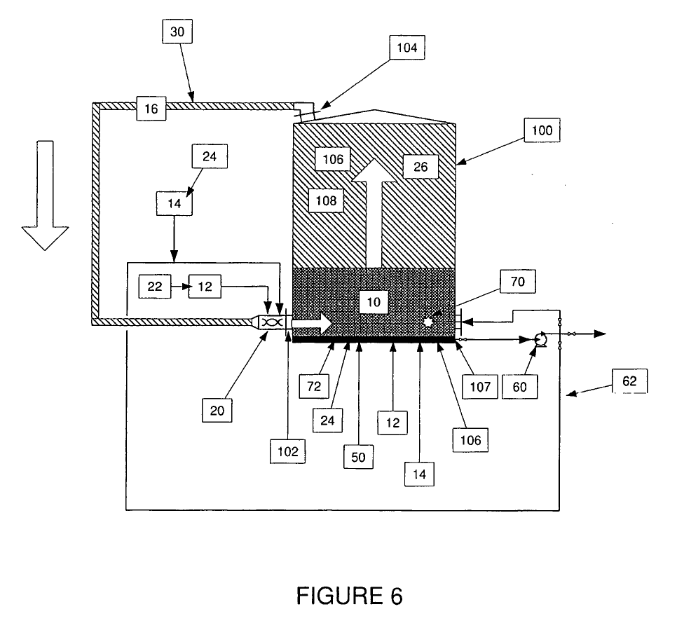

In another embodiment as depicted in FIG. 6, foam 10 is circulated as described above and can be used in conjunction with a mechanical cleaning device 70. Mechanical cleaning device 70 can be rotating jet cleaning machines, fixed pattern nozzles or a combination of both. In such an embodiment, cleaning solution 72 can be condensate 50 and/or a chemical product which does not significantly degrade the stability of foam 10 and/or react with extraction additive 19.

It will be understood that certain features and some combinations are of utility and may be employed without reference to other features and sub-combinations. This is contemplated by and is within the scope of the Claims. Since many possible embodiments may be made of the invention without departing from the scope thereof, it is to be understood that all matter herein set forth or shown in the accompanying drawings is to be interpreted as illustrative and not in a limiting sense.

We claim:

1. A foam system comprising:
A sufficient volume of stable foam introduced into an enclosed structure to displace residual material suspended in a vapor space within said enclosed structure to an exhaust duct fluidly connected to an outlet formed in said enclosed structure thereby eliminating or at least reducing the concentration of said residual material within said enclosed structure, wherein said foam comprises a plurality of bubbles created by a foam generator from a pre-determined ratio of foam concentrate, water and gas.

2. A foam system as claimed in claim 1, wherein said exhaust duct is fluidly connected to a control device to treat or destroy said residual material.

3. A foam system as claimed in claim 1, wherein said exhaust duct is fluidly connected to said foam generator to reduce the amount of said gas required to generate said foam.

4. A foam system as claimed in claim 3, wherein a drain is formed near the bottom of said enclosed structure to drain off said foam which has collapsed into a condensate comprising said foam concentrate, said water and said residual material to a recycle pump fluidly connected to said foam generator thereby resulting in the increase concentration of said residual material in said concentrate.

5. A foam system as claimed in claim 4, wherein said foam further comprises a extraction additive uniformly dispersed in the walls of said plurality of bubbles and formulated to interact with said residual material thereby resulting in an increase concentration of said residual material in said concentrate.

6. A foam system as claimed in claim 5, wherein a mechanical cleaning device located in said enclosed structure sprays a cleaning solution within the enclosed structure to enhance the removal of said residual material from said enclosed structure, and said cleaning solution is formulated to not breakdown said foam nor react with said foam concentrate.

7. A foam system as claimed in claim 3, wherein the bottom of said enclosed structure is covered at least in part by said residual material and said residual material is covered by a vapor barrier created from the collapse of said plurality of bubbles thereby preventing said residual material covering said bottom of enclosed structure from becoming suspended in said vapor space.
